(19) United States
(12) Patent Application Publication
(10) Pub. No.: US 2008/0147870 A1
(43) Pub. Date: Jun. 19, 2008

(54) SERVER, INFORMATION PROCESSING METHOD, SERVER PROGRAM AND SERVER SYSTEM

(75) Inventor: Kazuo TOMONO, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/857,834

(22) Filed: Sep. 19, 2007

(30) Foreign Application Priority Data
Dec. 15, 2006 (JP) JP2006-338911

(51) Int. Cl. G06F 15/16

(52) U.S. Cl. 709/228

(57) ABSTRACT

A server 2 includes a session checking unit 14 checking whether a session with a client 6 is maintained or not, a session information query unit 15 checking whether session information is accumulated in a database 4 or not, a session regenerating unit 16 requesting the database 4 for the session information of the client, and an access acknowledgment unit 17 acknowledging a request from the client when the session regenerating unit 16 stores the session information of the client 6 in the session information storage unit 13.

### BACKGROUND OF THE INVENTION

The present invention relates to a server, an information processing method, a server program and a server system.

Nowadays, a variety of contents and services are provided at Websites on the Internet. A user accesses a desired Website and is provided with the content and the service.

At the Website for distributing the contents, the user accessing the Website is requested to input a password etc and is thus authenticated in order to prevent an invalid access. For instance, Patent document 1 discloses a technology of preventing the invalid access through spoofing by requesting the user to input a tentative password known by only the user. Further, Patent document 2 discloses a network system configured so that when a user identifying information operation unit installed in the server updates user information, a user directory provided in each client is updated. Still further, Patent document 3 discloses a server system configured by including a center server receiving batchwise ID management information of the users whose usage registration is accepted by respective media servers, wherein the individual user is enabled to access any media servers by periodically updating the ID management information of the respective media servers.

[Patent document 1] Japanese Patent Application Laid-Open Publication No. 2001-337922

[Patent document 2] Japanese Patent Application Laid-Open Publication No. 8-221364

[Patent document 3] Japanese Patent Application Laid-Open Publication No. 8-255133

### SUMMARY OF THE INVENTION

With widespread of the Internet, the number of accesses to the Websites keeps on increasing. The load is shared (distributed) by installing a plurality of servers in order to facilitate maintenance and management of the servers that administer the Websites. The loads of the servers are distributed, and hence, if one server gets into a failure etc, other servers process the requests from the users.

In the case of the server operated in a status of maintaining a session between the user and the Website as at a shopping site and a stock site, items of data such as a numerical quantity of a commercial product placed in a cart by the user are accumulated in the server that keeps the session. In the case of a load-sharing type of server system, however, the respective servers do not share the information such as the numerical quantity of the commercial product, which is accumulated in each individual server. Accordingly, if the server maintaining the session with the user gets into system down due to the failure etc, another server takes over the operation of providing the service to the user through a load sharing device etc but does not take over the information etc of the commercial product in the cart that is accumulated in the failure-occurred server. Therefore, the user gets dissatisfied with a must-do-operation of placing again the commercial product etc into the cart.

It is therefore an object of the present invention to provide a technology of taking over a status of a session with a client between servers in a server system in which the plurality of servers is installed to be connected in parallel.

To solve the problems, according to the present invention, if a session with a client is not maintained, session information accumulated in a database is checked by querying a database. Then, the session with the client is restored based on the session information accumulated in the database.

To be more specific, a plurality of servers is installed to be connected in parallel between a client and

a database, the server comprising:

a Website having contents provided to the client; a session information storage unit stored with session information defined as information about a status of a session with the client accessing the Website;

a session checking unit querying, when the client makes a request for accessing the Website, the session information storage unit and thus checking whether the session with the client is maintained or not;

a session information query unit querying, when the session checking unit confirms that the session with the client is not maintained, the database and thus checking whether the session information of the client is accumulated in the database or not;

a session regenerating unit requesting, when the session information query unit confirms that the session information is accumulated, the database for the session information of the client, and storing the session information storage unit with the session information of which the database has notified; and

an access acknowledgement unit acknowledging the request given from the client when the session checking unit confirms that the session with the client is maintained, or when the session regenerating unit stores the session information of the client in the session information storage unit.

A premise is that the server according to the present invention is applied to a server system (e.g., a load sharing type of server system) in which the plurality of servers is installed to be connected in parallel between the client and the database. Each of the plural servers to be installed is connected to the same database. Note that the database is not limited to the single database, but a plurality of databases may be provided.

The Website is built up within the server according to the present invention. Further, the server comprises the session information storage unit, the session checking unit, the session information query unit, the session regenerating unit and the access acknowledgement unit.

When the client sends a request to the server, the session checking unit detects this request and checks a status of the session with the client by querying the session information storage unit. If it is confirmed that the session is maintained, the access acknowledgement unit acknowledges the request given from the client.

Herein, there might be a case in which the session checking unit confirms that the session is not maintained. For example, this case is exemplified in the way that the client newly accesses, and another server gets into the system down with the result that the allocation of the request from the client keeping the session with this server is changed.

Such being the case, if the session checking unit confirms that the session is not maintained, the session information query unit queries the database. This is because if the session information of the session between the server undergoing the system down and the client is accumulated within the database, the session with the client can be maintained based on this session information.

When the session information query unit confirms that the session information is accumulated, the session regenerating unit acquires this session information. The server can maintain the session with the client on the basis of the session information acquired from the database.

With the operation described above, when the plurality of servers according to the present invention is installed to be connected in parallel, the status of the session with the client can be taken over between the servers, and therefore the session with the client can be maintained even if the server accepting the request of the client is changed midway.

Moreover, the server may further comprise content transmitting unit transmitting, to an unspecified client, an unspecified content provided to the unspecified client till the access acknowledgement unit acknowledges the request given from the client, and transmitting, when the access acknowledgement unit acknowledges the request sent by the client, a specified content provided to only the request sender client to the same request sender client.

This configuration enables transmission of a content corresponding to the status of the session with the client.

Further, the server may further comprise session generating unit newly generating, when the session information query unit confirms that the session information is not accumulated, the session information for maintaining the session with the client, and storing the session information in the session information storage unit, wherein the access acknowledgement unit may acknowledge the request given from the client when the session checking unit confirms that the session with the client is maintained or when the session generating unit or the session regenerating unit stores the session information of the client in the session information storage unit.

With this configuration, a new session with the client can be established.

Still further, the server may further comprise database updating unit notifying, when the session generating unit generates new pieces of session information, the database of the session information and storing the session information in the database.

With this configuration, when the session between the client and the server is established, the session information is accumulated in the database, and hence the status of the newly established session with the client can be taken over between the servers.

Yet further, the Website may be a shopping site, and the session information may contain data of a commercial product for purchase that is sent from the client.

With this scheme, even if the server is switched over when the client conducts shopping at the shopping site, the data of the purchased commercial product placed into the cart by the client is taken over to another server, so that there is not any burden on the client.

Further, the present invention may also be an information processing method by which any one of the functions described above is executed. Still further, the present invention may also be a server program for making a server computer actualize any one of the functions described above. Yet further, the present invention may also be a readable-by-computer recording medium recorded with the server program.

Moreover, a server system according to the present invention comprises load distributing unit distributing requests from client to a plurality of servers, the plurality of servers connected to the load distributing unit, and a database connected to the plurality of servers. The load distributing unit may have a session maintaining function of allocating a plurality of requests from one client to the servers. The server may include a Website having contents provided to the client, a session information storage unit stored with session information defined as information about a status of a session with the client accessing the Website, session checking unit querying, when the client makes a request for accessing the Website, the session information storage unit and thus checking whether the session with the client is maintained or not, a session information query unit querying, when the session checking unit confirms that the session with the client is not maintained, the database and thus checking whether the session information of the client is accumulated in the database or not, a session regenerating unit requesting, when the session information query unit confirms that the session information is accumulated, the database for the session information of the client, and storing the session information storage unit with the session information of which the database has notified, and an access acknowledgement unit acknowledging the request given from the client when the session checking unit confirms that the session with the client is maintained, or when the session regenerating unit stores the session information of the client in the session information storage unit. The database may include session information accumulating unit accumulating the session information.

The status of the session with the client can be taken over between the servers in the server system where the plurality of servers is installed to be connected in parallel.

### BRIEF DESCRIPTION OF THE DRAWINGS

FIG. 1 is a diagram of a whole architecture of a server system;

FIG. 2 is a diagram of a whole configuration of a server;

FIG. 3 is a processing flowchart of the server;

FIG. 4 is a processing flowchart of the server system;

FIG. 5 is a processing flowchart of the server system.

### DETAILED DESCRIPTION OF THE INVENTION

A server, an information processing method, a program for the server and a server system according to an exemplary embodiment of the present invention will hereinafter be described with reference to the drawings. The present embodiment is an exemplification, and the present invention is not limited to this exemplification.

<Configuration>

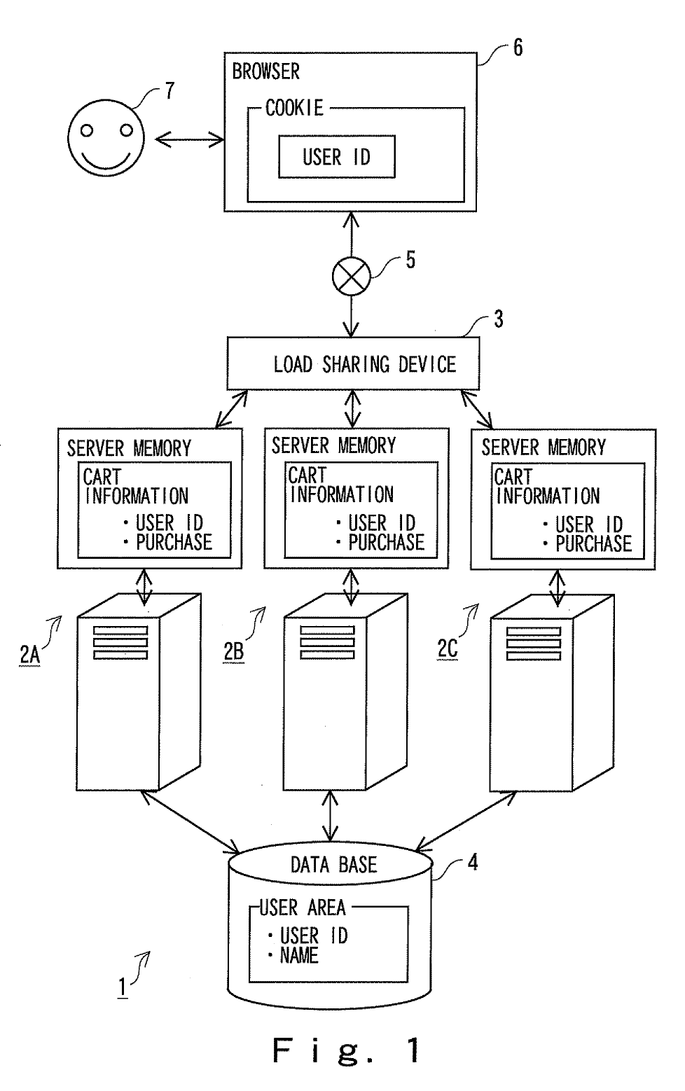

FIG. 1 is a diagram of a whole configuration of a server system 1 according to the present embodiment. As illustrated in FIG. 1, the server system 1 includes servers 2A, 2B and 2C, a load sharing device 3 and a database 4. As shown in FIG. 1, the server system 1 according to the present embodiment includes the three Web servers. Each of these three Web servers has the same components and the same function.

Further, as illustrated in FIG. 1, the server system 1 is so configured as to be connectable to a client 6 via the Internet 5. The client 6 is classified as a personal computer, and a scheme is that a user 7 is accessible to the server system 1 via the client 6. It should be noted that the personal computer is exemplified as the client 6, however, the present invention is not limited to the personal computer but shall embrace all of applicable information processing mediums accessible to the Internet such as a PDA (Personal Digital Assistant) and a mobile phone.

A premise in the present embodiment is, it is to be noted, that the client 6 is connected to the server system 1 via the Internet 5, however, the present invention is not limited to this premise. Namely, the client may be connected via an Intranet to the server system 1. Further, in the present embodiment, the server system 1 includes the three Web servers, however, the present invention is not restricted to the three Web servers. Namely, the server system 1 may include two Web servers and may also include four or more Web servers. Still further, a configuration in the present embodiment is that the plural servers (Web servers) are installed to be connected in parallel so as to exhibit the effects of the invention. The server according to the present invention is not, however, a server that does not exhibit the server function if the server system is configured by only one server. FIG. 1 illustrates only one client 6, however, the present invention is not limited to the single client, and an assumption is that a multiplicity of clients is connected.

The load sharing device 3 allocates requests of the clients 6 accessing the Web servers via the Internet 5, corresponding to statuses of loads etc of the respective servers 2A, 2B and 2C. To be specific, if the number of requests (request count) processed by the server 2A gets approximate to an upper limit value of a throughput, the load sharing device 3 allocates the requests to the server having comparatively a small number of requests processed therein. With this scheme, the loads on the respective servers 2A, 2B and 2C are properly shared.

Note that the load sharing device 3 has a configuration capable of detecting a failure etc of the server and then allocating the requests as well as allocating the requests corresponding to the loads on the respective servers 2A, 2B and 2C. A method by which the load sharing device 3 detects the failure in any one of the servers 2A, 2B and 2C is exemplified by a method of detecting the failure in a way that receives an abnormality signal transmitted from the failure-occurred server, or by a method of detecting the failure in the server from recognition that the request allocated to the specified server is not processed even after an elapse of a fixed period of time. Further, the load sharing device 3 has a session maintaining function, wherein the scheme is that the requests sent from the same client 6 within a fixed period of time (e.g., 1 minute) are transmitted to the same server 2.

The database 4 is constructed of a storage medium (corresponding to [session information accumulating unit] according to the present invention) etc capable of accumulating the data sent from the servers 2A, 2B and 2C and providing the data to the servers 2A, 2B and 2C. The database 4 may be constructed of a server computer including a large-capacity hard disk etc, and may also be constructed of storage mediums provided with a multiplicity of magnetic storage tapes etc.

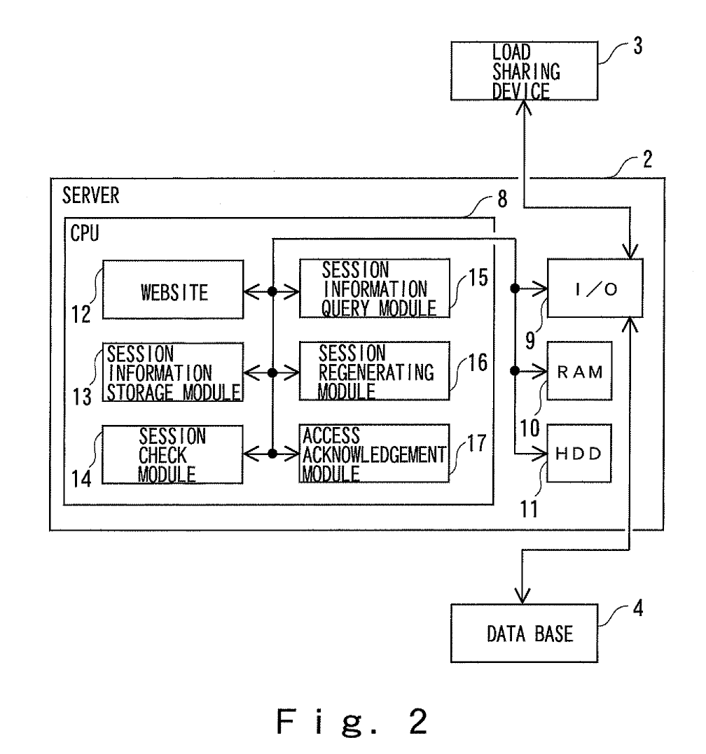

FIG. 2 is a diagram of the whole configuration of one of the servers 2A, 2B and 2C. The configuration of the server 2 will hereinafter be described with reference to FIG. 2. Note that each of the servers 2A, 2B and 2C has the same configuration, and hence, for the explanation's sake, one server will be explained.

As illustrated in FIG. 2, the server 2 is constructed of a CPU (Central Processing Unit) 8, an input/output interface 9, a RAM (Random Access Memory) 10, a HDD (Hard Disk Drive) 11, and so on. In the server 2, a program for the server according to the present invention is executed inside, thereby realizing various functions thereof. In the server 2, when the server program is executed, there are configured a Website 12, a session information storage module 13, a session check module 14, a session information query module 15, a session regenerating module 16 and an access acknowledgement module 17.

The Website 12 is organized by contents provided to the clients 6. The Website 12 is organized by content pages (corresponding to [specified contents] according to the present invention) provided in a session-maintained status (i.e., a log-in status) with the client 6 and by guest-oriented content pages (corresponding to [unspecified contents] according to the present invention) provided in a session unmaintained status (i.e., a log-out status) with the client 6.

The session information storage module 13 stores session information in the RAM 10, the HDD 11, etc. Herein, “the session information” connotes information used for the server 2 to specify the client 6, and is exemplified by, a user ID and a name of the user 7, and authentication header information etc contained in the request of the client 6. Further, the session information contains data about a numerical quantity etc of a commercial product placed in a cart by the client 6 on the Website 12. The server 2 specifies the client 6 on the basis of the session information, and maintains a connection status (session status) with the client 6. Note that “the session” connotes a series of status in which the server 2 and the client 6 perform communications in a way that specifies the communication partner with each other. Moreover, “the status in which the session is maintained” connotes a status continued till an end of the communication between the server 2 and the client 6 in a way that specifies the communication partners with each other since the communication has been started.

The session check module 14 checks whether the session with the client 6 transmitting the request is maintained or not. The session check module 14, when checking the session status, queries the session information storage module 13. The session information storage module 13, if associated items of the session information are stored in the RAM 10 and in the HDD 11, notifies the session check module 14 of these items of session information.

The session information query module 15 queries the database 4 about the data therein via the I/O interface 9. The session information query module 15 is so configured as to be capable of detecting whether the associated session information is accumulated in the database 4 or not.

The session regenerating module 16 acquires the session information from the database 4 via the I/O interface 9. The session regenerating module 16, upon acquiring the session information, stores the session information in the session information storage module 13.

The session regenerating module 16, if the session information could be acquired from the database 4, stores the acquired session information in the session information storage module 13. With this operation, the session information is accumulated in the server 2, whereby the session with the client 6 can be again maintained.

The access acknowledgement module 17, if the session information is stored in the session information storage module 13, acknowledges the request sent from the client 6. When the access acknowledgement module 17 acknowledges the request, the Website 12 is enabled to transmit a specified content etc provided to only the approved client 6.

<Processing Flow>

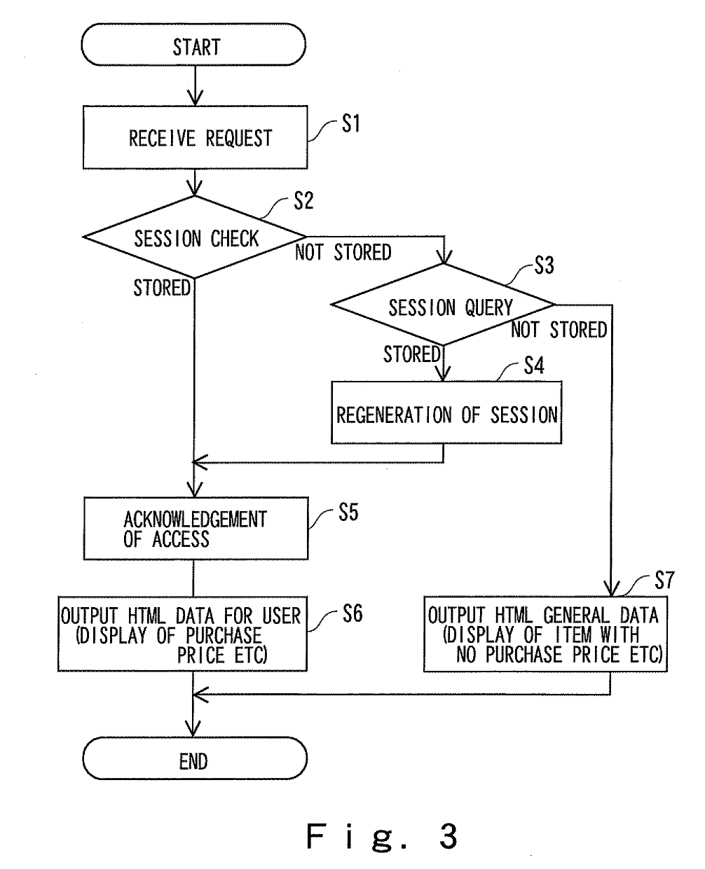

A flow of information processing executed by the server 2 will be explained. FIG. 3 is a flowchart showing the flow of the information processing conducted within the server 2. The processing flow will be described with reference to the flowchart in FIG. 3.

The session check module 14 of the server 2A receives the request from the client 6 via the Internet 5 and via the load sharing device 3 (step S1).

The session check module 14 of the server 2A, when receiving the request from the client 6, queries the session information storage module 13 and checks whether the session is maintained or not (step S2). Herein, the load sharing device 3 has the session maintaining function as described above. Accordingly, the client 6 has already logged in the server 2A, and the processing proceeds to step S5 if the session is maintained.

The access acknowledgement module 17, as the session check module 14 has already confirmed that the session with the client 6 is maintained, acknowledges the request given from the client 6 (step S5). Thus, the information security is strengthened by acknowledging the request of the client 6 in a way that checks the session.

The Website 12 of the server 2A, upon receiving the acknowledgement of the access acknowledgement module 17, sends HTML (HyperText Markup Language) page data etc (the specified pages) for the user to the client 6 (step S6). The user 7 is thereby able to continue the shopping by putting a commercial product in the cart on a shopping site etc.

Hereat, if the server 2A keeping the session with the client 6 gets into system down or the like, the load sharing device 3 detects the system down of the server 2A, and allocates the request from the client 6 to another server 2 (e.g., the server 2B). Hence, it follows that the request from the client 6 is sent to the server 2B that has kept none of the session so far. In the server 2B receiving the request from the client 6, the following process is executed.

Specifically, the session check module 14 of the server 2B receives the request from the client 6 via the Internet 5 and via the load sharing device 3 (step S1).

The session check module 14 of the server 2B, when receiving the request from the client 6, queries the session information storage module 13 and checks whether the session is maintained or not (step S2). Hereat, any session is not yet established between the client 6 and the server 2B. Hence, the processing proceeds to step S3.

The session information query module 15 of the server 2B queries the database 4 and checks whether the session information of the client 6 is accumulated or not (step S3) If the server 2A keeping the session with the client 6 has already stored the session information in the database 4, the data thereof is searched for. Hence, the processing proceeds to step S4. Note that the session information stored in the database 4 is the information stored in the database 4 by the server 2A when the client 6 newly accessed the server 2A and when the session was established between the client 6 and the server 2A.

The session regenerating module 16 of the server 2B acquires the session information searched out of the database 4 and stores the acquired session information in the session information storage module 13 (step S4). The session can be thereby maintained between the server 2B and the client 6. Therefore, the processing proceeds to step S5. Note that step S5 and step S6 are the same as those described above, and hence their explanations are omitted.

If the server 2A keeping the session with the client 6 has not stored the session information in the database 4, it follows that the session information for keeping the session with the client 6 is not left in the server system 1. Accordingly, in this case, the processing proceeds to step S7, and the Website 12 of the server 2B transmits the HTML page data etc for the general purpose to the client 6 (step S7).

<Effects>

Owing to the contrivance described above, even if the server 2A gets into the system down with the result that the session between the server 2A and the client 6 is terminated, the session is again established between the server 2B and the client 6. Therefore, even when the load sharing device 3 switches over the server 2, it does not happen that the client 6 and the user 7 are forced to have a burden of re-inputting the log-in ID and the commercial product placed in the cart. Further, the database 4 provides the session information if a malfunction occurs in the server 2. Namely, the access from the client 6 is handled in each of the servers 2. Accordingly, the database can be efficiently employed by reducing an access count to the database 4. Moreover, it is considered that the system down of the server 2 is caused by an overflow of the memory of the server 2 as well as by the failure. In such a case, however, another server 2 takes over the session information accumulated in the server 2 undergoing the system down, thereby enabling the request from the client 6 to be properly processed.

It is to be noted that the specification has discussed the case in which the server 2A gets into the system down while the server 2B processes the request of the client 6, however, the same function is, as a matter of course, realized in the way that one of the servers 2 processes the request of the client 6 if any one of the servers 2A, 2B and 2C get into the system down.

Note that the server 2 may include a content transmitting module etc that transmits the contents of the Website 12 to the client 6. Further, the server 2 may further include a session generating module that generates new items of session information by prompting the client 6 to input the log-in ID etc if the server system 1 has no remainder of the session information of the client 6 (i.e., when the client 6 tries to newly access the server 2 and if any session is not established between the client 6 and the server 2, or if the session is terminated before storing, irrespective of keeping the session between the client 6 and one of the servers 2, the session information thereof in the database 4). The server 2 may still further include a database updating module that updates, when new items of session information is generated, the information in the database 4 by uploading the session information into the database 4.

Herein, the accumulated session information in the database 4 may be deleted from the database 4 after an elapse of a fixed period of time. Namely, the server 2 keeping the session with the client 6 might, it is considered, get into the system down due to the failure etc after uploading and storing the session information of the client 6 into the database 4. In this case, it follows that the session information of the client 6 remains for any length of time in the database 4. Then, such a session information discarding module may be provided as to discard the session information having the elapse of the fixed period of time since being stored in the database 4. It should be noted that the session information discarding module may discard the session information having the elapse of the fixed period of time since being stored, may also discard the session information as triggered by having no access from any one of the servers 2A, 2B and 2C, and may further discard the session information when receiving a session cancelling request from the client 6.

<Outline 1 of Processing Flow>

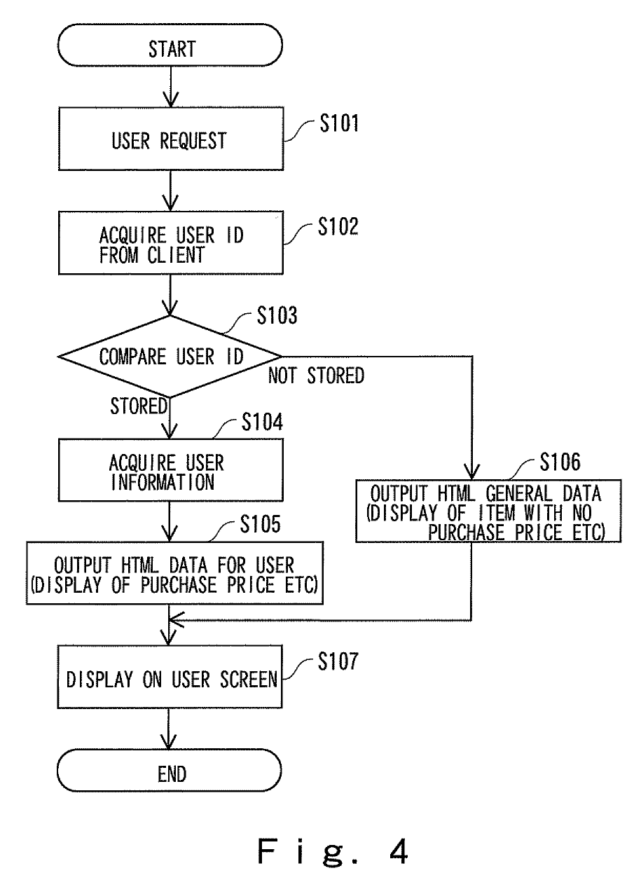

An outline of an information processing flow of the server system 1 will be described. Explained herein is a processing flow in a case where all of the servers 2A, 2B and 2C normally operate, and the load sharing device 3 does not change the session between the client 6 and the server 2. FIG. 4 is a processing flowchart of the server system 1. The information processing flow will hereinafter be described with reference to the flowchart in FIG. 4.

The load sharing device 3, upon receiving the request sent from the client 6, sends the request to any one of the servers 2A, 2B and 2C (step S101).

The session check module 14 acquires the items of session information such as the user ID, the name, etc from the request sent from the load sharing device 3 (step S102)

The session check module 14 queries the session information storage module 13 and checks whether or not the session information corresponding to the session information acquired in step S102 is stored in the session information storage module 13 (step S103). If the session information is stored in the session information storage module 13, the session check module 14 determines that the session between the client 6 and the server 2 is maintained, and advances to step S104. Whereas if the session information is not stored in the session information storage module 13, the session check module 14 determines that the session between the client 6 and the server 2 is not maintained, and advances to step S106.

The Website 12 acquires the user information such as a numerical quantity of the purchased commercial product from the client 6 confirmed so that its session is maintained (step S104).

The Website 12 calculates a purchase price from the information such as the numerical quantity of the purchased commercial product that is acquired from the client 6, and outputs the HTML-formatted page data representing the purchase price of the specified content provided to only the user 7 (step S105).

Note that the Website 12, if unable to confirm the session of the client 6 in step S103, outputs HTML-formatted page data representing general information of unspecified contents provided to unspecified users (step S106).

The client 6 displays the page data transmitted from the Website 12 in step S105 or S106 on a user screen of the display (step S107).

<Outline 2 of Processing Flow>

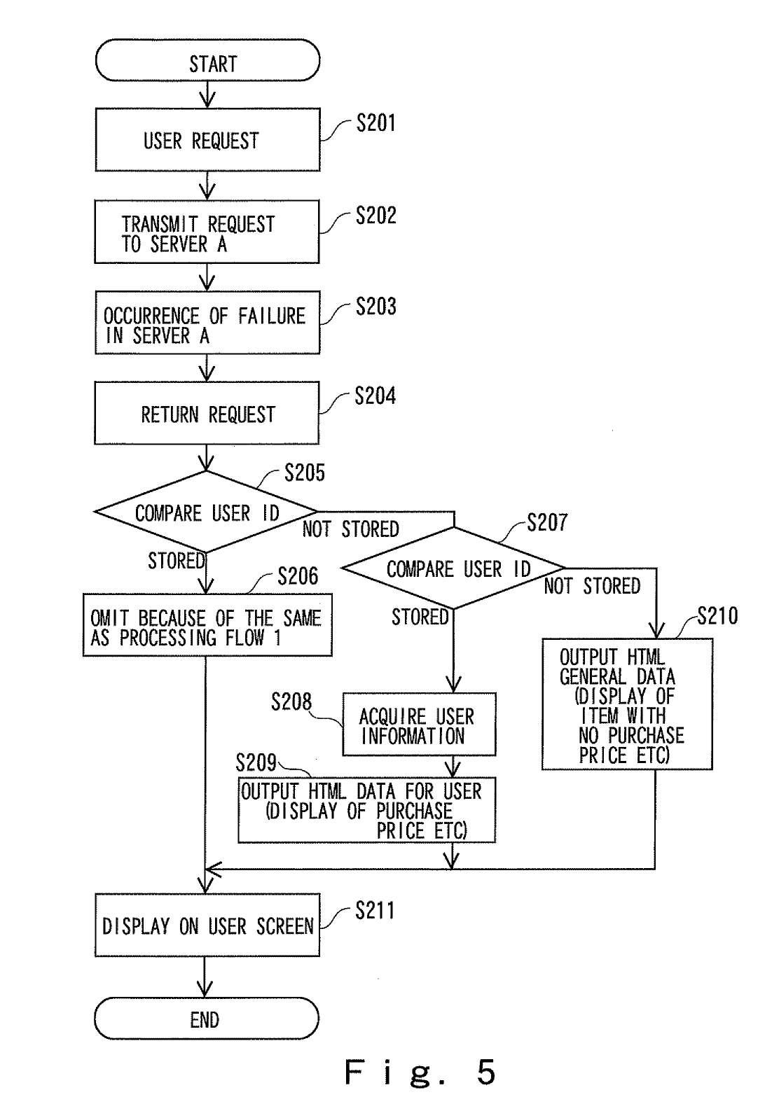

The information processing flow of the server system 1 will be described. Explained herein is a processing flow in a case where any one of the servers 2A, 2B and 2C gets into the system down, and the load sharing device 3 changes the session between the client 6 and the server 2. FIG. 5 is a flowchart of the server system 1. The information processing flow will hereinafter be described with reference to the flowchart in FIG. 5.

The client 6 transmits the request in response to an input given from the user 7 to the server system 1 (step S201).

The load sharing device 3, upon receiving the request sent from the client 6, sends this request to any one of the servers 2A, 2B and 2C (step S202). An assumption herein is that the session of the client 6 is set to the server 2A by the session maintaining function of the load sharing device 3. Accordingly, the load sharing device 3 transmits the request sent from the client 6 to the server 2A.

Hereat, if the failure occurs in the server 2A (step S203), the request transmitted to the server 2A is sent back to the load sharing device 3 (step S204) and is retransmitted to another server 2B or 2C. The present processing flow exemplifies a case in which the request is sent to the server 2B.

The session check module 14 in the server 2B queries the session information storage module 13 and checks whether or not the session information is stored in the session information storage module 13 (step S205). The session of the client 6 is, however, kept with the server 2A, and hence the session information storage module 13 in the server 2B is stored with none of the session information of the client 6. The processing therefore proceeds to step S207.

Next, the session information query module 15 in the server 2B queries the database 4 and checks whether the session information exists in the database 4 or not (step S207). The processing proceeds to step S208 if the session information of the client 6 exists in the database 4 but diverts to step S210 whereas if the session information of the client 6 does not exist in the database 4.

The session regenerating module 16 in the server 2B, if the session information of the client 6 exists in the database 4, stores the session information in the session information storage module 13 (step S208). Through this operation, the access acknowledgement module 17 acknowledges the request given from the client 6, and the session between the server 2B and the client 6 is restored.

The Website 12 in the server 2B, when the access acknowledgement module 17 acknowledges the request given from the client 6, transmits the user-oriented HTML page data etc of the specified content to the client 6 (step S209).

Moreover, the Website 12 in the server 2B, when the access acknowledgement module 17 does not acknowledge the request given from the client 6, transmits the general-purpose HTML page data etc of the unspecified content to the client 6 (step S210).

The client 6 displays on the screen the HTML page data sent from the Website 12 in the server 2B (step S211). The disclosures of Japanese patent application No. JP2006-338911 filed on Dec. 15, 2006 including the specification, drawings and abstract are incorporated herein by reference.

What is claimed is:

1. A plurality of servers installed to be connected in parallel between a client and a database, the server comprising:
a Website having contents provided to the client;
a session information storage unit stored with session information defined as information about a status of a session with the client accessing the Website;
a session checking unit querying, when the client makes a request for accessing the Website, the session information storage unit and thus checking whether the session with the client is maintained or not;
a session information query unit querying, when the session checking unit confirms that the session with the client is not maintained, the database and thus checking whether the session information of the client is accumulated in the database or not;
a session regenerating unit requesting, when the session information query unit confirms that the session information is accumulated, the database for the session information of the client, and storing the session information storage unit with the session information of which the database has notified; and
an access acknowledgement unit acknowledging the request given from the client when the session checking unit confirms that the session with the client is maintained, or when the session regenerating unit stores the session information of the client in the session information storage unit.

2. The server according to claim 1, further comprising content transmitting unit transmitting, to an unspecified client, an unspecified content provided to the unspecified client till the access acknowledgement unit acknowledges the request given from the client, and transmitting, when the access acknowledgement unit acknowledges the request sent by the client, a specified content provided to only the request sender client to the same request sender client.

3. The server according to claim 1, further comprising session generating unit newly generating, when the session information query unit confirms that the session information is not accumulated, the session information for maintaining the session with the client, and storing the session information in the session information storage unit, wherein the access acknowledgement unit acknowledges the request given from the client when the session checking unit confirms that the session with the client is maintained or when the session generating unit or the session regenerating unit stores the session information of the client in the session information storage unit.

4. The server according to claim 3, further comprising database updating unit notifying, when the session generating unit generates new pieces of session information, the database of the session information and storing the session information in the database.

5. The server according to claim 1, wherein the Website is a shopping site, and
the session information contains data of a commercial product for purchase that is sent from the client.

6. An information processing method executed by a plurality of servers installed to be connected in parallel between a client and a database, the method comprising:
a session checking step of querying, when the client makes a request for accessing a Website, an information storage unit stored with session information defined as information about a status of a session with the client and thus checking whether the session with the client is maintained or not;
a session information query step of querying, when it is confirmed in the session checking step that the session with the client is not maintained, the database and thus checking whether the session information of the client is accumulated in the database or not;
a session regenerating step of requesting, when it is confirmed in the session information query step that the session information is accumulated, the database for the session information of the client, and storing the session information storage unit with the session information of which the database has notified; and
an access acknowledgement step of acknowledging the request given from the client when confirming in the session checking step that the session with the client is maintained, or when storing the session information of the client in the session information storage unit in the session regenerating step.

7. The information processing method according to claim 6, further comprising a content transmitting step of transmitting, to an unspecified client, an unspecified content provided to the unspecified client till the request given from the client is acknowledged in the access acknowledgement step, and transmitting, when the request sent by the client is acknowledged in the access acknowledgement step, a specified content provided to only the request sender client to the same request sender client.

8. The information processing method according to claim 6, further comprising a session generating step of newly generating, when confirming in the session information query step that the session information is not accumulated, the session information for maintaining the session with the client, and storing the session information in the session information storage unit,
wherein the access acknowledgement step includes acknowledging the request given from the client when confirming in the session checking step confirms that the session with the client is maintained or when storing the session information of the client in the session information storage unit in the session generating step or the session regenerating step.

9. The information processing method according to claim 8, further comprising a database updating step of notifying, when new pieces of session information are generated in the session generating step, the database of the session information and storing the session information in the database.

10. The information processing method according to claim 6, wherein the Website is a shopping site, and
the session information contains data of a commercial product for purchase that is sent from the client.

11. A recoding medium recorded a server program for a plurality of servers installed to be connected in parallel between a client and a database, the program making a server computer execute:
a session checking step of querying, when the client makes a request for accessing a Website, an information storage unit stored with session information defined as information about a status of a session with the client and thus checking whether the session with the client is maintained or not;
a session information query step of querying, when it is confirmed in the session checking step that the session with the client is not maintained, the database and thus checking whether the session information of the client is accumulated in the database or not;
a session regenerating step of requesting, when it is confirmed in the session information query step that the session information is accumulated, the database for the session information of the client, and storing the session information storage unit with the session information of which the database has notified; and
an access acknowledgement step of acknowledging the request given from the client when confirming in the session checking step that the session with the client is maintained, or when storing the session information of the client in the session information storage unit in the session regenerating step.

12. The recoding medium recorded a server program according to claim 11, further comprising a content transmitting step of transmitting, to an unspecified client, an unspecified content provided to the unspecified client till the request given from the client is acknowledged in the access acknowledgement step, and transmitting, when the request sent by the client is acknowledged in the access acknowledgement step, a specified content provided to only the request sender client to the same request sender client.

13. The recoding medium recorded a server program according to claim 11, further comprising a session generating step of newly generating, when confirming in the session information query step that the session information is not accumulated, the session information for maintaining the session with the client, and storing the session information in the session information storage unit,
wherein the access acknowledgement step includes acknowledging the request given from the client when confirming in the session checking step confirms that the session with the client is maintained or when storing the session information of the client in the session information storage unit in the session generating step or the session regenerating step.

14. The recoding medium recorded a server program according to claim 13, further comprising a database updating step of notifying, when new pieces of session information are generated in the session generating step, the database of the session information and storing the session information in the database.

15. The recoding medium recorded a server program according to claim 11, wherein the Website is a shopping site, and
the session information contains data of a commercial product for purchase that is sent from the client.

16. A server system comprising:
a load distributing unit distributing requests from client to a plurality of servers,
a plurality of servers connected to the load distributing unit; and
a database connected to the plurality of servers, the load distributing unit having:
a session maintaining function of allocating a plurality of requests from one client to the servers,
the server including:
a Website having contents provided to the client;
a session information storage unit stored with session information defined as information about a status of a session with the client accessing the Website;
a session checking unit querying, when the client makes a request for accessing the Website, the session information storage unit and thus checking whether the session with the client is maintained or not;
a session information query unit querying, when the session checking unit confirms that the session with the client is not maintained, the database and thus checking whether the session information of the client is accumulated in the database or not;
a session regenerating unit requesting, when the session information query unit confirms that the session information is accumulated, the database for the session information of the client, and storing the session information storage unit with the session information of which the database has notified; and
an access acknowledgement unit acknowledging the request given from the client when the session checking unit confirms that the session with the client is maintained, or when the session regenerating unit stores the session information of the client in the session information storage unit, and
the database including:
a session information accumulating unit accumulating the session information.

17. The server system according to claim 16, wherein the server further includes a content transmitting unit transmitting, to an unspecified client, an unspecified content provided to the unspecified client till the access acknowledgement unit acknowledges the request given from the client, and transmitting, when the access acknowledgement unit acknowledges the request sent by the client, a specified content provided to only the request sender client to the same request sender client.

18. The server system according to claim 16, wherein the server further includes a session generating unit newly generating, when the session information query unit confirms that the session information is not accumulated, the session information for maintaining the session with the client, and storing the session information in the session information storage unit,
wherein the access acknowledgement unit acknowledges the request given from the client when the session checking unit confirms that the session with the client is maintained or when the session generating unit or the session regenerating unit stores the session information of the client in the session information storage unit.

19. The server system according to claim 18, wherein the server further includes database updating unit notifying, when the session generating unit generates new pieces of session information, the database of the session information and storing the session information in the database.

20. The server system according to claim 16, wherein the Website is a shopping site, and
the session information contains data of a commercial product for purchase that is sent from the client.
